(19) United States
(12) Patent Application Publication
(10) Pub. No.: US 2010/0262423 A1
(43) Pub. Date: Oct. 14, 2010

(54) FEATURE COMPENSATION APPROACH TO ROBUST SPEECH RECOGNITION

(75) Inventors: Qiang Huo, Beijing (CN); Jun Du, Hefei (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/422,314

(22) Filed: Apr. 13, 2009

(51) Int. Cl. G10L 15/20

(52) U.S. Cl. 704/233; 704/E15.004

(57) ABSTRACT

Described is a technology by which a feature compensation approach to speech recognition uses a high-order vector Taylor series (HOVTS) approximation of a model of distortions to improve recognition accuracy. Speech recognizer models trained with clean speech degrade when later dealing with speech that is corrupted by additive noises and convolutional distortions. The approach attempts to remove any such noise/distortions from the input speech. To use the HOVTS approximation, a Gaussian mixture model is trained and used to convert cepstral domain feature vectors to log spectrum components. HOVTS computes statistics for the components, which are transformed back to the cepstral domain. A noise/distortion estimate is obtained, and used to provide a clean speech estimate to the recognizer.

### BACKGROUND

Most contemporary automatic speech recognition (ASR) systems use MFCCs (Mel-frequency cepstral coefficients) and their derivatives as speech features, and a set of Gaussian mixture continuous density hidden Markov models (CDHMMs) for modeling basic speech units. The models are trained with clean speech. However, in practice, speech is often not clean but corrupted by noise and/or distortion.

It is well known that the performance of such an automatic speech recognition system trained with clean speech will degrade significantly when later dealing with speech that is corrupted by additive noises from the surrounding environment. Recognition performance will also degrade because of convolutional distortions, such as resulting from the use of a different type of microphone/transducer than the type used in training, and/or from the speech traveling over different transmission channels.

Various approaches to deal with the corrupted speech problem have been attempted. Any improvement over existing technology in dealing with the corrupted speech problem is desirable for use in automatic speech recognition systems.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a feature compensation mechanism receives feature vectors corresponding to (possibly) corrupted speech, and uses a high-order vector Taylor series approximation to approximate a model of distortions to modify the feature vectors into compensated feature vectors corresponding to a clean speech estimate. The clean speech estimate, such as in the form of normalized feature vectors, is provided to a speech recognizer for recognition.

In one aspect, a feature extraction mechanism extracts a series of Mel-frequency cepstral coefficient feature vectors from frames of input speech. The feature compensation mechanism includes an inverse discrete cosine transform mechanism that uses a clean-speech trained Gaussian mixture model to compute log spectrum Gaussian mixture model components from the input feature vectors of cepstral domain. The high-order vector Taylor series approximation is used to calculate statistics from the Gaussian mixture model components. A discrete cosine transform mechanism transforms the statistics back to the cepstral domain, where they are used to re-estimate noise parameters. The re-estimation may be performed a plurality of times (e.g., three or four) by iterating accordingly.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components of a feature compensation approach for estimating clean speech from possibly corrupted speech using high-order vector Taylor series approximations.

FIG. 2 is a flow diagram showing example steps for estimating clean speech from possibly corrupted speech using high-order vector Taylor series approximations.

FIG. 3 shows an illustrative example of a computing environment into which various aspects of the present invention may be incorporated.

### DETAILED DESCRIPTION

Various aspects of the technology described herein are generally directed towards improving speech recognition accuracy by compensating for additive noise and/or convolutional distortion using a high-order vector Taylor series (HOVTS) approximation of an explicit model of distortions. This provides a compensation approach to robust speech recognition that consistently and significantly improves recognition accuracy compared to traditional first-order (simple linear approximation) VTS-based feature compensation approaches. Also described is deriving formulations for maximum likelihood (ML) estimation of noise model parameters and minimum mean squared error (MMSE) estimation of clean speech.

It should be understood that the components and steps described herein are only examples of a suitable implementation. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and speech processing in general.

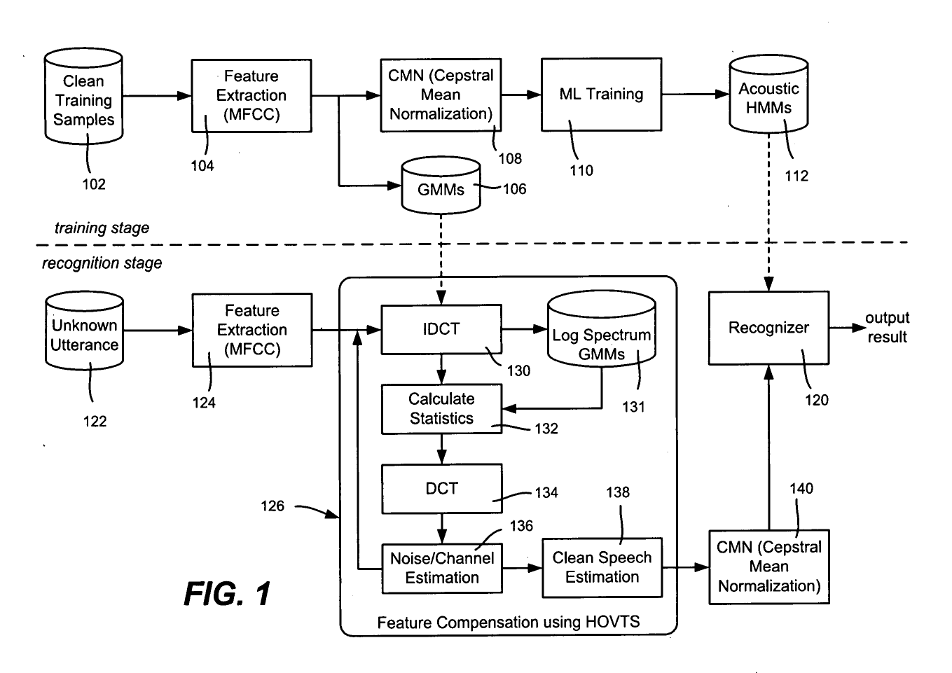

Turning to FIG. 1, there are shown example components of a feature compensation approach as described herein. In one aspect, a training stage is represented, typically performed offline, as well as a recognition stage, performed as speech is received online.

In the training stage, given clean training samples 102, feature extraction 104 based upon Mel-frequency cepstral coefficients (MFCC) obtains MFCC feature vectors in a known manner. The feature vectors are used to train one or more Gaussian mixture model (GMMs) 106 as a reference of the clean speech model, used as described below. Note that in one implementation, the GMMs are not given a filter meaning for each Gaussian component, but rather a in a feature space for all sounds in the particular language being recognized. Further, the feature vectors are normalized (via cepstral mean normalization, or CMN 108), for use in maximum likelihood (ML) training 110 to provide acoustic Hidden Markov Models 112 for later online use by a recognizer 120.

In the recognition stage, an unknown utterance 122, which may or may not be clean with respect to noise or distortion, is recognized. In general, MFCC feature extraction 124 provides a sequence of MFCC feature vectors for a set of input frames. The sequence of frames are modified by a feature compensation using HOVTS mechanism 126 (as described in detail below) into another sequence of MFCC feature vectors, which generally have at least some of any additive noise/convolutional noise removed. The compensated feature vectors are normalized via cepstral mean normalization 140 for recognition by the recognizer 120, using the training acoustic HMMs, into an output result in a known manner.

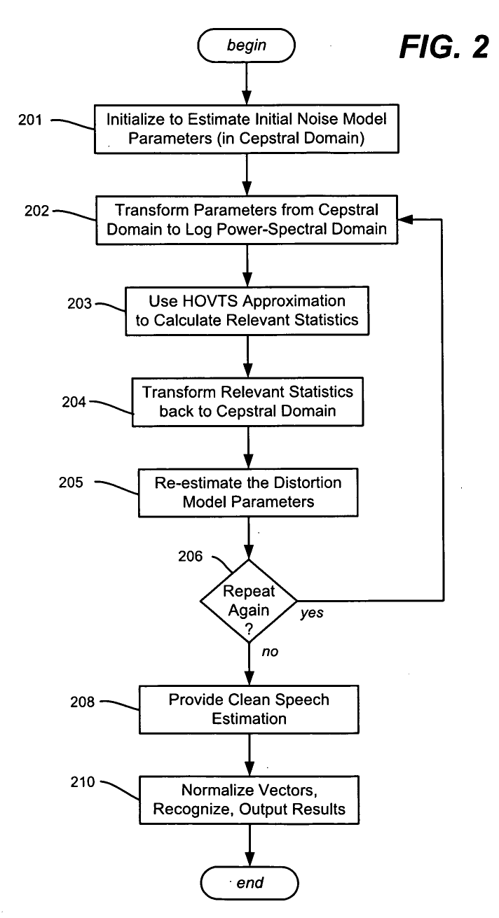

FIG. 2 and the components within the mechanism 126 describe one implementation of the HOVTS-based approach. This approach assumes that in the time domain, the “corrupted” speech y[t] is subject to the following distortion model:

y[t]=x[t]\textcircled{*}h[t]+n[t] (1)

where independent signals x[t], h[t] and n[t] represent the t^{th} sample of clean speech, the convolutional (e.g., transducer and transmission channel) distortion and the additive (e.g., environmental) noise, respectively.

Then, a frame of speech as represented by its feature vector in the cepstral domain may be transformed into a feature vector in the log power-spectrum domain. More particularly, by ignoring correlations between different filter banks, the distortion model in the log power-spectrum domain can be expressed approximately as

exp(y)=exp(x+h)+exp(n) (2)

where y, x, h and n are log power-spectrums in a particular channel of the filterbank of clean speech, convolutional term and noise, respectively.

However, the nonlinear nature of the above distortion model makes statistical modeling and inference of the above variables difficult, whereby certain approximations are made. Traditional approximation was performed via a first-order (simple linear approximation) VTS-based feature compensation approach. As described herein, a more accurate approximation is based upon HOVTS, and provides improved recognition accuracy.

To this end, the above nonlinear distortion function may be expanded using HOVTS. Then a linear function is found to approximate the above HOVTS by minimizing the mean-squared error incurred by this approximation. Given the linear function, the remaining inference is the same as in using the traditional first-order VTS to approximate the nonlinear distortion function directly. HOVTS is used to approximate the nonlinear portion of the distortion function by expanding with respect to n−x instead of (x, n). In one implementation, both approaches work for each feature dimension independently by ignoring correlations among different channels of filterbank. Note however that correlations among different channels of the filterbank may be considered in alternative implementations.

The above nonlinear distortion function may be approximated by a second-order VTS. Using this relation, the mean vector of the relevant noisy speech feature vector can be derived, which includes a term related to the second order term in HOVTS. Note however that the nonlinear distortion function can be approximated by HOVTS with any order (that is, not only a second order).

In the above-described training stage, a Gaussian mixture model (GMM) 106,

$$p ( {x}_{t}^{c} ) = {\sum }_{m = 1}^{M} {ω}_{m} N ( {x}_{t}^{c} ; {μ}_{x , m}^{c} , {\sum }_{x , m}^{c} ) ,$$

was trained from clean speech using MFCC features without cepstral mean normalization (CMN), where

$${μ}_{x , m}^{c} , {\sum }_{x , m}^{c} ,$$

and wₘ are mean vector, diagonal covariance matrix and mixture weight of the m^{th} component, respectively. Assume that for each sentence, the noise feature vector n^{c} in cepstral domain follows a Gaussian PDF (probability density function) with a mean vector μₙ^{c} and a diagonal covariance matrix Σₙ^{c}, which can be estimated in the recognition stage as represented in the steps 201-206 of FIG. 2 and described below.

Step 201 represents initialization, wherein in general, the mechanism 126 initializes parameters by using the first j (e.g., ten) frames to obtain a noise/channel estimation. More particularly, one implementation estimates the initial noise model parameters in the cepstral domain by taking the sample mean and covariance matrix of the MFCC features from the first j (e.g., ten) frames of the unknown utterance, and sets h^{c} as a zero vector.

Step 202 is performed in order to more easily calculate the statistics that are later used to re-estimate noise. As h is deterministic, and x is assumed to follow the GMM, the inverse discrete cosine transform (IDCT) block 130 transforms the parameters from cepstral domain to log power-spectral domain. To this end, a new random vector, z^{c}=x^{c}+h^{c}, is defined, whose PDF can be derived as follows:

$$p ( {z}_{t}^{c} ) = {\sum }_{m = 1}^{M} {ω}_{m} N ( {z}_{t}^{c} ; {μ}_{x , m}^{c} + {h}^{c} , {\sum }_{x , m}^{c} ) .$$

More particularly, the parameters are transformed from the cepstral domain to the log-power-spectral domain (represented by the GMMs 131 of FIG. 1) as follows:

$$\begin{matrix}{μ}_{x , m}^{1} = {C}^{+} {μ}_{x , m}^{c} & ( 3 ) \\ {\sum }_{x , m}^{1} = {C}^{+} {\sum }_{x , m}^{c} {( {C}^{+} )}^{T} & ( 4 ) \\ {μ}_{n}^{1} = {c}^{+} {μ}_{n}^{c} & ( 5 ) \\ {\sum }_{n}^{1} = {c}^{+} {\sum }_{n}^{c} {( {C}^{+} )}^{T} . & ( 6 )\end{matrix}$$

where C⁺ is the Moore-Penrose inverse of the discrete cosine transform (DCT) matrix C, and the superscripts ‘I’ and ‘c’ indicate the log-power-spectral domain and cepstral domain, respectively.

Step 203 of FIG. 2 and block 132 of FIG. 1 represents calculating the relevant statistics

$${μ}_{y , m}^{1} , , {Σ}_{y , m}^{1} , {Σ}_{xy , m}^{1} , {Σ}_{ny , m}^{1} ,$$

which are used for noise re-estimation and clean speech estimation, using HOVTS approximation in the log-power-spectral domain. Additional details of this calculation are described below.

Step 204 of FIG. 2 and DCT block 134 of FIG. 1 transform the above statistics back to the cepstral domain as follows:

$$\begin{matrix}{μ}_{y , m}^{c} = C {μ}_{y , m}^{1} & ( 7 ) \\ {Σ}_{y , m}^{c} = C {Σ}_{y , m}^{1} {( C )}^{⊤} & ( 8 ) \\ {Σ}_{xy , m}^{c} = C {{Σ}_{xy , m}^{1} ( C )}^{⊤} & ( 9 ) \\ {Σ}_{ny , m}^{c} = C {Σ}_{ny , m}^{1} {( C )}^{⊤} . & ( 10 )\end{matrix}$$

Step 205 of FIG. 2 and block 136 of FIG. 1 use the following updating formulas to re-estimate (update) the noise model parameters:

$$\begin{matrix}{\overline{μ}}_{n} = \frac{{\sum }_{t = 1}^{T} {\sum }_{m = 1}^{M} P ( m \vert {y}_{t} ) {E}_{n} [ {n}_{t} \vert {y}_{t} , m ]}{{\sum }_{t = 1}^{T} {\sum }_{m = 1}^{M} P ( m \vert {y}_{t} )} & ( 11 ) \\ {\overline{Σ}}_{n} = \frac{{\sum }_{t = 1}^{T} {\sum }_{m = 1}^{M} P ( m \vert {y}_{t} ) {E}_{n} [ {n}_{t} {n}_{t}^{⊤} \vert {y}_{t} , m ]}{{\sum }_{t = 1}^{T} {\sum }_{m = 1}^{M} P ( m \vert {y}_{t} )} - {\overline{μ}}_{n} {\overline{μ}}_{n}^{⊤} & ( 12 ) \\ \overline{h} = \begin{matrix}{[ {\sum }_{t = 1}^{T} {\sum }_{m = 1}^{M} P ( m \vert {y}_{t} ) {\sum }_{x , m}^{- 1} ]}^{- 1} \\ [ {\sum }_{t = 1}^{T} {\sum }_{m = 1}^{M} P ( m \vert {y}_{t} ) {Σ}_{x , m}^{- 1} ( {E}_{z} [ {z}_{t} \vert {y}_{t} , m ] - {μ}_{x , m} ) ]\end{matrix} \\ where & ( 13 ) \\ P ( m \vert {y}_{t} ) = \frac{{ω}_{m} {p}_{y} ( {y}_{t} \vert m )}{{\sum }_{l = 1}^{M} {ω}_{l} {p}_{y} ( {y}_{t} \vert l )} . & ( 14 )\end{matrix}$$

Note that in the above equations, the cepstral domain indicator “c” was dropped in relevant variables for notational convenience. Further,

$${p}_{y} ( {y}_{t} ) = {\sum }_{m = 1}^{M} {ω}_{m} {p}_{y} ( {y}_{t} \vert m )$$

is the PDF of the noisy speech yₜ, where the true p_{y}(yₜ|m) is approximated by a Gaussian PDF, N(yₜ; μ_{y,m}, Σ_{y,m}), via “moment-matching”. Eₙ[nₜ|yₜ, m], Eₙ[nₜnₜ^{T}|yₜ, m] and E_{z}[zₜ|yₜ, m] are the relevant conditional expectations evaluated as follows:

$$\begin{matrix} {E}_{n} [ {n}_{t} \vert {y}_{t} , m ] = {μ}_{n} + {Σ}_{ny , m} {Σ}_{y , m}^{- 1} ( {y}_{t} - {μ}_{y , m} ) & ( 15 ) \\ {E}_{n} [ {n}_{t} {n}_{t}^{⊤} \vert {y}_{t} , m ] = {E}_{n} [ {n}_{t} \vert {y}_{t} , m ] {E}_{n}^{⊤} [ {n}_{t} \vert {y}_{t} , m ] + {Σ}_{n} - {Σ}_{ny , m} {Σ}_{y , m}^{- 1} {Σ}_{yn , m} & ( 16 ) \\ {E}_{z} [ {z}_{t} \vert {y}_{t} , m ] = ( {μ}_{x , m} + h ) + {Σ}_{zy , m} {Σ}_{y , m}^{- 1} ( {y}_{t} - {μ}_{y , m} ) . & ( 17 )\end{matrix}$$

Step 206 of FIG. 2 represents repeating steps 202 to 205 multiple times (e.g., generally on the order of three or four iterations is sufficient). The noise estimation is thus (typically) improved with respect to that provided by a single iteration.

Given the noisy speech and noise estimation, the minimum mean-squared error (MMSE) estimation of clean speech feature vector in the cepstral domain can be calculated (step 208 of FIG. 2 and block 138 of FIG. 1) as

$${\hat{x}}_{t} = {E}_{x} [ {x}_{t} \vert {y}_{t} ] = {\sum }_{m = 1}^{M} P ( m \vert {y}_{t} ) {E}_{x} [ {x}_{t} \vert {y}_{t} , m ] \qquad ( 18 )$$

where Eₓ[xₜ|yₜ, m] is the conditional expectation of xₜ given yₜ for the m^{th} mixture component, and can be evaluated as follows:

Eₓ[xₜ|yₜ,m]=E_{z}[zₜ|yₜ,m]−h (19)

For completeness, step 210, along with the cepstral mean normalization block 140 and the recognizer 120, represent normalizing the compensated feature vectors, recognizing the speech, and outputting results (e.g., text).

Turning to additional details on calculating the statistics

$${μ}_{y , m}^{1} , {Σ}_{y , m}^{1} , {Σ}_{xy , m}^{1} , {Σ}_{ny , m}^{1} ,$$

using the HOVTS approximation of the nonlinear distortion function of Equation (2), note that z in Equations (1) through (19) is represented by x in the following description. For notational convenience, the indices related to the frame number, mixture component, and channel index of the filterbank are dropped.

The explicit distortion model in Equation (2) may be reformulated in the scalar form as follows:

y=f(x,n)=log(exp(x)+exp(n)). (20)

Then, the K-order Taylor series of f(x; n) with the expansion point (μₓ; μₙ) may be represented as:

$$\begin{matrix}{f}_{K} ( x , n ) = {\sum }_{k = 0}^{K} {\frac{1}{k !} [ ( x - {μ}_{x} ) \frac{\partial }{\partial x} + ( n - {μ}_{n} ) \frac{\partial }{\partial n} ]}^{k} f ( {μ}_{x} , {μ}_{n} ) \\ = {\sum }_{k = 0}^{K} {\sum }_{r = 0}^{k} A ( k , r ) {( x - {μ}_{x} )}^{k - r} {( n - {μ}_{n} )}^{r}\end{matrix} \qquad ( 21 )$$

where

$$A ( k , r ) = \frac{1}{r ! ( k - r ) !} \frac{{\partial }^{k} f ( x , n )}{\partial {x}^{k - r} \partial {n}^{r}} {\vert}_{( {μ}_{x} , {μ}_{n} )} \qquad ( 22 )$$

and

$$\frac{{\partial }^{k} f ( x , n )}{\partial {x}^{k - r} \partial {n}^{r}} {\vert}_{( {μ}_{x} , {μ}_{n} )} = \{ \begin{matrix}log ( exp ( {μ}_{x} ) + exp ( {μ}_{n} ) ) , & k = 0 , r = 0 \\ 1 - \frac{1}{1 + exp ( {μ}_{n} - {μ}_{x} )} , & k = 1 , r = 1 \\ \frac{1}{1 + exp ( {μ}_{n} - {μ}_{x} )} , & k = 1 , r = 0 \\ {( - 1 )}^{k - r} {\sum }_{p = 1}^{k} \frac{B ( k , p )}{{[ 1 + exp ( {μ}_{n} - {μ}_{x} ) ]}^{p}} , & k > 1\end{matrix} . \qquad ( 23 )$$

When k>1 and k≧p≧1, the coefficients B(k; p) in Equation (23) can be evaluated by using the following recursive relation

B(k,p)=(p−1)B(k−1,p−1)−pB(k−1,p) (24)

with the initial condition

B(1,1)=−1,B(k,0)=B(k,k+1)=0,k≧1. (25)

For convenience, the following expectations are defined:

Eₓₙⁱ[g(x,n)]=∫∫g(xⁱ,nⁱ)pₓₙ(xⁱ,nⁱ)dxⁱdnⁱ (26)

Eₓₙ^{ij}[g(x,m), h(x,n)]=∫∫∫∫g(xⁱ,nⁱ)h(x^{j},n^{j})pₓₙ(xⁱ,x^{j}, nⁱ,n^{j})dxⁱdx^{j}dnⁱdn^{j} (27)

where g(xⁱ, nⁱ) and h(x^{j}, n^{j}) are two general functions, i and j are dimensional indices. Given the above notations and results, the main statistics required in implementing the feature compensation approach are summarized.

To calculate μ_{y}(i), which denotes the ith element of the vector μ_{y}, using the definition of the mean parameter gives

$$\begin{matrix}\begin{matrix}{μ}_{y} ( i ) \approx {E}_{xn}^{i} [ {f}_{K} ( x , n ) ] \\ = {\sum }_{k = 0}^{K} {\sum }_{r = 0}^{k} {A}^{i} ( k , r ) {E}_{xn}^{i} [ {( x - {μ}_{x} )}^{k - r} {( n - {μ}_{n} )}^{r} ] \\ = {\sum }_{k = 0}^{K} {\sum }_{r = 0}^{k} {A}^{i} ( k , r ) {M}_{n}^{i} ( r ) {M}_{x}^{i} ( k - r )\end{matrix} & ( 28 ) \\ {M}_{Δ}^{i} ( p ) = \{ \begin{matrix}0 , & if p is odd \\ ( p - 1 ) !! {σ}_{Δ}^{p} ( i ) , & otherwise\end{matrix} & ( 29 )\end{matrix}$$

where Δ represents ‘x’ or ‘n’. Aⁱ(k; r) is the value of Equation (22) for the i^{th} dimension.

To calculate σ_{y}²(i; j) to denote the (i; j)^{th} element of the matrix Σ_{y}, using the definition of the covariance gives

$$\begin{matrix}{σ}_{y}^{2} ( i , j ) \approx {E}_{xn}^{ij} [ {f}_{K} ( x , n ) , {f}_{K} ( x , n ) ] - {μ}_{y} ( i ) {μ}_{y} ( j ) \\ = {\sum }_{{k}_{1} = 0}^{K} {\sum }_{{r}_{1} = 0}^{{k}_{1}} {\sum }_{{k}_{2} = 0}^{K} {\sum }_{{r}_{2} = 0}^{{k}_{2}} {A}^{i} ( {k}_{1} , {r}_{1} ) {A}^{j} ( {k}_{2} , {r}_{2} ) {M}_{n}^{ij} ( {r}_{1} , {r}_{2} ) \\ {M}_{x}^{ij} ( {k}_{1} - {r}_{1} , {k}_{2} - {r}_{2} ) - {μ}_{y} ( i ) {μ}_{y} ( j )\end{matrix} \qquad ( 30 )$$

where

$${M}_{Δ}^{ij} ( p , q ) = \{ \begin{matrix}0 , & if p + q is odd \\ p ! q ! {2}^{- \frac{p + q}{2}} {\sum }_{0 \leq l \leq min ( p , q )}^{p - l is even} & \\ \frac{{2}^{l}}{l ! ( \frac{p - l}{2} ) ! ( \frac{q - l}{2} ) !} {σ}_{Δ}^{p - l} ( i , i ) & \\ {σ}_{Δ}^{2 l} ( i , j ) {σ}_{Δ}^{q - l} ( j , j ) , & otherwise .\end{matrix} \qquad ( 31 )$$

To calculate σ_{xy}²(i; j) to denote the (i; j)th element of the matrix Σ_{xy}, using the definition of the covariance parameter gives

$$\begin{matrix}{σ}_{xy}^{2} ( i , j ) = {E}_{xn}^{ij} [ ( x - {μ}_{x} ) , ( y - {μ}_{y} ) ] \\ = {\sum }_{k = 0}^{K} {\sum }_{r = 0}^{k} {A}^{j} ( k , r ) {M}_{n}^{j} ( r ) {M}_{x}^{ij} ( 1 , k - r ) .\end{matrix} \qquad ( 32 )$$

To calculate σ_{ny}²(i; j) to denote the (i; j)th element of the matrix Σ_{ny}, using the definition of the covariance parameter gives

$$\begin{matrix}{σ}_{ny}^{2} ( i , j ) = {E}_{xn}^{ij} [ ( n - {μ}_{n} ) , ( y - {μ}_{y} ) ] \\ = {\sum }_{k = 0}^{K} {\sum }_{r = 0}^{k} {A}^{j} ( k , r ) {M}_{n}^{ij} ( 1 , r ) {M}_{x}^{j} ( k - r ) .\end{matrix} \qquad ( 33 )$$

### Exemplary Operating Environment

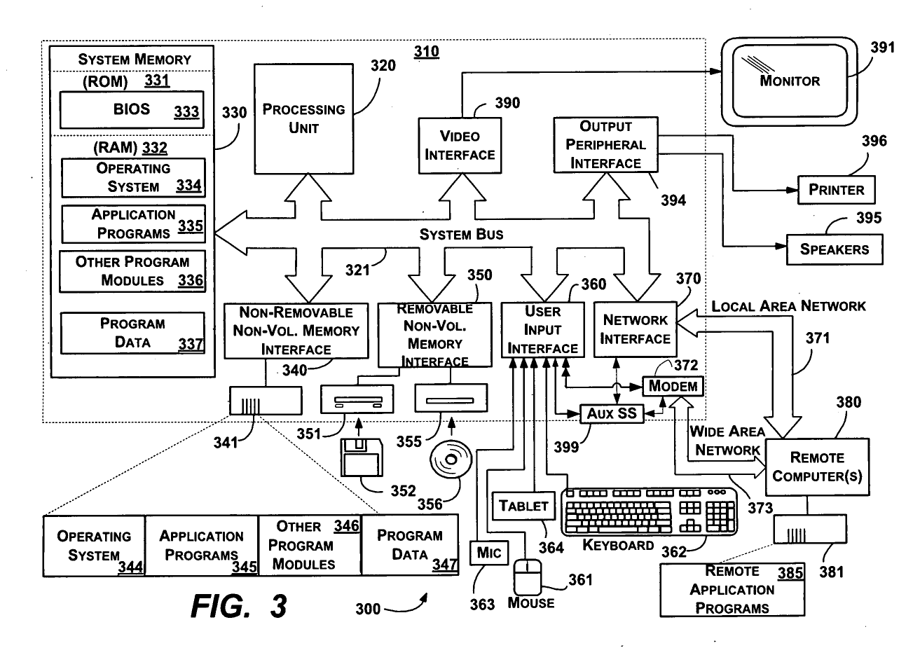

FIG. 3 illustrates an example of a suitable computing and networking environment 300 on which the examples of FIGS. 1-2 may be implemented. The computing system environment 300 is only one example of a suitable computing environment and is not intended to suggest any limitation as to the scope of use or functionality of the invention. Neither should the computing environment 300 be interpreted as having any dependency or requirement relating to any one or combination of components illustrated in the exemplary operating environment 300.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 3, an exemplary system for implementing various aspects of the invention may include a general purpose computing device in the form of a computer 310. Components of the computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 310 typically includes a variety of computer-readable media. Computer-readable media can be any available media that can be accessed by the computer 310 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 310. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336 and program data 337.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media, described above and illustrated in FIG. 3, provide storage of computer-readable instructions, data structures, program modules and other data for the computer 310. In FIG. 3, for example, hard disk drive 341 is illustrated as storing operating system 344, application programs 345, other program modules 346 and program data 347. Note that these components can either be the same as or different from operating system 334, application programs 335, other program modules 336, and program data 337. Operating system 344, application programs 345, other program modules 346, and program data 347 are given different numbers herein to illustrate that, at a minimum, they are different copies. A user may enter commands and information into the computer 310 through input devices such as a tablet, or electronic digitizer, 364, a microphone 363, a keyboard 362 and pointing device 361, commonly referred to as mouse, trackball or touch pad. Other input devices not shown in FIG. 3 may include a joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. The monitor 391 may also be integrated with a touch-screen panel or the like. Note that the monitor and/or touch screen panel can be physically coupled to a housing in which the computing device 310 is incorporated, such as in a tablet-type personal computer. In addition, computers such as the computing device 310 may also include other peripheral output devices such as speakers 395 and printer 396, which may be connected through an output peripheral interface 394 or the like.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include one or more local area networks (LAN) 371 and one or more wide area networks (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360 or other appropriate mechanism. A wireless networking component 374 such as comprising an interface and antenna may be coupled through a suitable device such as an access point or peer computer to a WAN or LAN. In a networked environment, program modules depicted relative to the computer 310, or portions thereof, may be stored in the remote memory storage device. By way of example, and not limitation, FIG. 3 illustrates remote application programs 385 as residing on memory device 381. It may be appreciated that the network connections shown are exemplary and other means of establishing a communications link between the computers may be used.

An auxiliary subsystem 399 (e.g., for auxiliary display of content) may be connected via the user interface 360 to allow data such as program content, system status and event notifications to be provided to the user, even if the main portions of the computer system are in a low power state. The auxiliary subsystem 399 may be connected to the modem 372 and/or network interface 370 to allow communication between these systems while the main processing unit 320 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a method comprising, receiving feature vectors for an unknown utterance, compensating for additive noises or convolutional distortions, or both additive noise and convolutional distortions, including by using a high-order vector Taylor series approximation of a model of distortions to provide compensated feature vectors to a speech recognizer.

2. The method of claim 1 wherein the feature vectors are cepstral domain feature vectors, and further comprising, using a plurality of frames to estimate noise model parameters in the cepstral domain.

3. The method of claim 2 further comprising, transforming the noise model parameters from the cepstral domain to log power-spectral domain noise model parameters.

4. The method of claim 3 further comprising, training with clean speech to produce at least one Gaussian mixture model used in transforming the noise model parameters.

5. The method of claim 4 wherein training with clean speech further comprises performing maximum likelihood training to produce acoustic models.

6. The method of claim 3 wherein using the high-order vector Taylor series approximation comprises computing relevant statistics representing the log power-spectral domain noise model parameters.

7. The method of claim 6 further comprising, transforming the relevant statistics from the log power-spectral domain into transformed statistics in the cepstral domain.

8. The method of claim 7 further comprising, using the transformed statistics to re-estimate the noise model parameters.

9. The method of claim 8 further comprising, using the re-estimated noise model parameters to provide the compensated feature vectors to the speech recognizer.

10. The method of claim 7 further comprising, normalizing the compensated feature vectors.

11. In a computing environment, a system comprising,
a feature extraction mechanism that extracts a series of Mel-frequency cepstral coefficient feature vectors from frames of input speech, and
a feature compensation mechanism that receives the feature vectors, and uses a high-order vector Taylor series approximation to approximate a model of distortions to modify the feature vectors into compensated feature vectors corresponding to a clean speech estimate, for recognition into text by a speech recognizer.

12. The system of claim 11 wherein the feature compensation mechanism includes an inverse discrete cosine transform mechanism that uses a clean-speech trained Gaussian mixture model to compute log spectrum Gaussian mixture model components from the input feature vectors of cepstral domain, wherein the high-order vector Taylor series approximation calculates statistics from the Gaussian mixture model components, and wherein the feature compensation mechanism further includes a discrete cosine transform mechanism that transforms the statistics back to the cepstral domain.

13. The system of claim 12 wherein the feature compensation mechanism repeats processing by the discrete cosine transform mechanism, the high-order vector Taylor series approximation, and processing by discrete cosine transform for a plurality of iterations to update the noise channel estimation a plurality of times.

14. The system of claim 11 wherein the high-order vector Taylor series approximation comprises a second order approximation.

15. The system of claim 11 wherein a cepstral mean normalization component that normalizes the compensated feature vectors before providing the clean speech estimate to the recognizer.

16. One or more computer-readable media having computer-executable instructions, which when executed perform steps, comprising:
(a) receiving cepstral domain feature vectors for an unknown utterance;
(b) using a plurality of frames to estimate noise model parameters in the cepstral domain;
(c) transforming the noise model parameters from the cepstral domain to log power-spectral domain noise model parameters;
(d) computing relevant statistics representing the log power-spectral domain noise model parameters using a high-order vector Taylor series approximation;
(e) transforming the relevant statistics from the log power-spectral domain into transformed statistics in the cepstral domain;
(f) using the transformed statistics to re-estimate the noise model parameters; and
(g) using the re-estimated noise model parameters to provide data corresponding to a clean speech estimate to a speech recognizer.

17. The one or more computer-readable media of claim 16 having further computer-executable instructions comprising, repeating steps (c)-(f) a plurality of times.

18. The one or more computer-readable media of claim 16 wherein the clean speech estimate comprises compensated feature vectors in the cepstral domain, and having further computer-executable instructions comprising, normalizing the compensated feature vectors before providing the data to the speech recognizer.

19. The one or more computer-readable media of claim 16 having further computer-executable instructions comprising, training with clean speech to produce at least one Gaussian mixture model used in transforming the noise model parameters.

20. The one or more computer-readable media of claim 19 wherein training with the clean speech further comprises performing maximum likelihood training to produce acoustic models.
